(19) United States
(12) Patent Application Publication
(10) Pub. No.: US 2026/0101176 A1
(43) Pub. Date: Apr. 9, 2026

(54) METHODS, ARCHITECTURES, APPARATUSES AND SYSTEMS FOR DEVICE ASSOCIATION OVER DIRECT COMMUNICATION FOR AGGREGATED DEVICES

(71) Applicant: InterDigital Patent Holdings, Inc., Wilmington, DE (US)

(72) Inventors: Magurawalage Chathura Madhusanka SARATHCHANDRA, London (GB); Filipe Conceicao, London (GB); Tezcan Cogalan, London (GB); Alain Mourad, Ascot (GB); Michelle Perras, Montreal (CA); Jaya Rao, Montreal (CA); Michael Starsinic, Newtown, PA (US); Saad Ahmad, Montreal (CA)

(21) Appl. No.: 19/116,816

(22) PCT Filed: Sep. 25, 2023
(86) PCT No.: PCT/US2023/033573

§ 371 Date: Mar. 28, 2025

Related U.S. Application Data
(60) Provisional application No. 63/410,699, filed on Sep. 28, 2022.

(51) Int. Cl. H04W 8/24

(52) U.S. Cl. CPC H04W 8/24

(57) ABSTRACT

Procedures, methods, architectures, apparatuses, systems, devices, and computer program products directed to artificial intelligence-specific idle/inactive/connected mode measurements procedure. In an embodiment, a method implemented by a wireless transmit receive unit (WTRU) includes receiving, from a network component, a first message comprising aggregation related information; registering with the network component, indicating capability/availability on multiple WTRUs aggregation; receiving, from the network component a second message comprising registration accept information for aggregation; and establishing sidelink communication with the multiple WTRUs.

### CROSS-REFERENCE TO RELATED APPLICATIONS

The present application claims the benefit of U.S. Provisional Patent Application No. 63/410,699 filed Sep. 28, 2022, which is incorporated herein by reference.

### TECHNICAL FIELD

The present disclosure is generally directed to the fields of communications, software and encoding, including, for example, to methods, architectures, apparatuses, systems directed to device association over direct communication for aggregated devices.

### BACKGROUND

Device-to-Device (D2D) direct communication protocols may enable two devices to communicate directly between them with or without the aid of the network. Different scenarios exist for D2D communication depending on whether wireless transmitter/receiver units (WTRUs) involved are within or not the coverage of a cellular network. In 3GPP, 5G NR Sidelink (SL) was introduced in Release 16 to enable proximate devices to directly communicate without packets going through the 3GPP network. Targeted applications may include mission critical services, V2X services and Industrial Internet of Things (IIoT). D2D communication promises ultra-low latency links and is therefore an attractive solution for various emerging applications such as AR, VR, XR.

It supports two key technologies, 1) proximity services (ProSe) and 2) group communication. ProSe services may allow devices which are within proximity to each other to communicate with each other. This is enabled by D2D discovery and D2D direct communication procedures. Discovery mechanisms may allow a WTRU to discover another WTRU in its proximity, which may be performed directly by WTRU or through the network. Group communication mechanisms may allow one-to-many communication among WTRUs in a highly resource efficient manner, allowing messages to be disseminated easily to a large group of people, over a common downlink stream.

For unicast communication, communicating entities may use layer-2 identifier (ID) for uniquely identifying the WTRUs. An application layer ID may be associated with one or more V2X applications within the same WTRU, while in scenarios where the WTRU has more than one application layer ID, each application layer ID of the same WTRU is seen as a different WTRU. The WTRU may maintain the application layer ID and the layer-2 IDs used for unicast links, and the applications may not use the layer-2 IDs and instead may use application layer ID, allowing to change the layer-2 IDs without requiring to update the applications.

User IDs such as EPC ProSe user ID may uniquely identify a WTRU registered for ProSe. Application layer group ID may uniquely identify an application layer group that the WTRU belongs to, a user within the context of a specific application or a group of users within the context of a specific application. According to “TS 23.304, Proximity based Services (ProSe) in the 5G System (5GS) (Release 17); V17.3.0”, for commercial services, the application layer group ID is provided by application server; and for public safety services, the pre-configured or provisioned application layer group ID will be used for groupcast communication.

To provide a single service, application and experience for a single user using multiple devices at the same time, there is a need for enhance mechanisms to associate, connect and manage multiple WTRUs together.

### SUMMARY

In an embodiment, a method implemented by a wireless transmit receive unit, WTRU, may comprise a step of transmitting, to a network, a registration request message for aggregation comprising first information indicating a WTRU capability on multiple WTRUs aggregation. The method may further comprise a step of receiving, from the network, a registration accept message comprising second information indicating aggregation related information. The method may further comprise a step of transmitting, to the network, a message comprising third information indicating completion of the aggregation registration; and a step of establishing sidelink communication with multiple WTRUs based on the aggregation related information.

The aggregation related information may comprise any of one or more WTRU identifiers, a WTRU aggregation identifier, a time window for the WTRU aggregation, and a subscriber identifier. The WTRU capability/availability may comprise an indication whether WTRU supports single WTRU aggregation or multiple simultaneous WTRU aggregation. The sidelink establishment communication may be based on preconfigured trigger event. The WTRU may be, may be configured as and/or configured with elements of, a base station.

In an embodiment, a method implemented by a wireless transmit receive unit, WTRU, may comprise a step of receiving, from a network, a first message comprising a WTRU first aggregation revocation notification including identifiers of one or more WTRUs to be revoked from multiple WTRUs associated with an aggregation of the WTRU. The method may further comprise a step of transmitting a revocation request message to the one or more WTRUs to be revoked; and a step of receiving, from the one or more WTRUs to be revoked, a revocation response message.

The method may further comprise an additional step of transmitting, to the non-revoked WTRUs from the multiple WTRUs, a second aggregation revocation notification including identifiers of the one or more revoked WTRUs; wherein the second aggregation revocation notification may comprise information indicating releasing any resources associated with the one or more revoked WTRUs.

In an embodiment, a method implemented by a first wireless transmit receive unit, WTRU, may comprise a step of receiving a WTRU aggregation event for triggering a registration request message for a WTRU aggregation of the first WTRU with a second WTRU. The method may further comprise a step of transmitting to the second WTRU the registration request message comprising information indicating the WTRU aggregation wherein the second WTRU is registered to the WTRU aggregation. The method may further comprise a step of receiving, from the second WTRU, a registration accept message for first WTRU registration with the WTRU aggregation; and a step of establishing a sidelink communication with the second WTRU.

The WTRU aggregation event may comprise any of application information for WTRU aggregation and a scheduled application event. Establishing the sidelink communication may comprise exchanging information related to any of a direction communication, an IP communication related information, and QoS information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communication system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of a single aggregation of a collection of WTRUs for the purpose of providing an application experience for a single user;

FIG. 3 is a block diagram illustrating an example of the relationship between a WTRU aggregation ID and other IDs, aggregated WTRUs, and a user;

FIG. 4 is a message flow diagram illustrating an example of a WTRU reception of aggregation parameters;

FIG. 5 is a message flow diagram illustrating an example of a WTRU triggered registration procedure;

FIG. 6 is a message flow diagram illustrating an example of procedures for establishing direct communication among WTRUs that are participating in a WTRU aggregation;

FIG. 7 is a message flow diagram illustrating an example of revoking WTRU memberships from a WTRU aggregation.

FIG. 8 is a flow chart illustrating an example of a method, implemented in a WTRU, for aggregating a WTRU to a WTRU aggregation;

FIG. 9 is a flow chart illustrating an example of a method, implemented in a WTRU, for revoking WTRU memberships from a WTRU aggregation; and

FIG. 10 is a flow chart illustrating an example of a method, implemented in a WTRU, for WTRU aggregation of a first WTRU to a second WTRU part of the WTRU aggregation.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

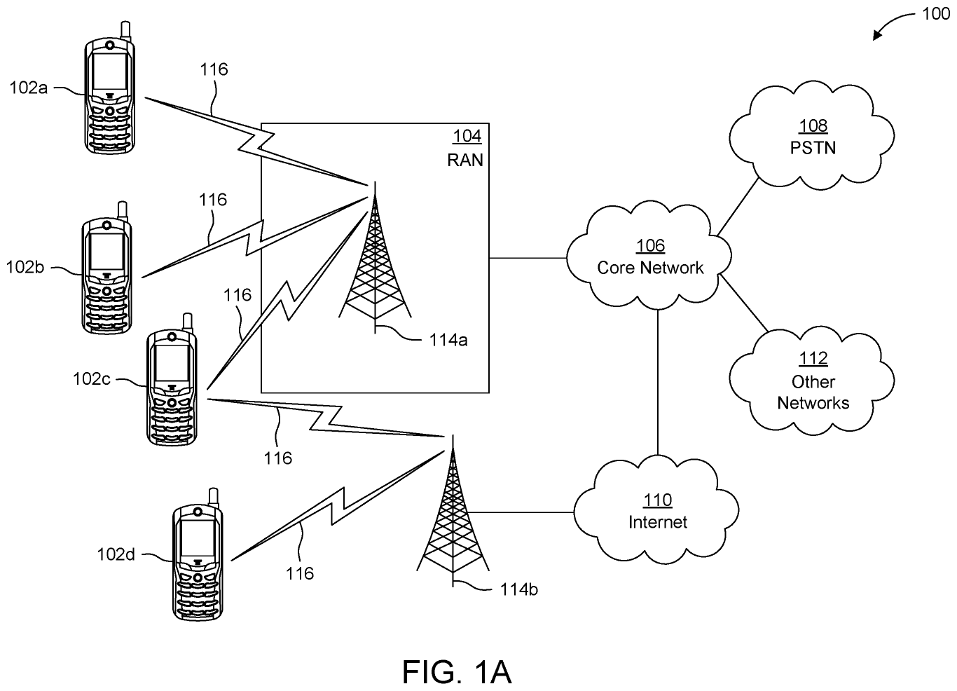

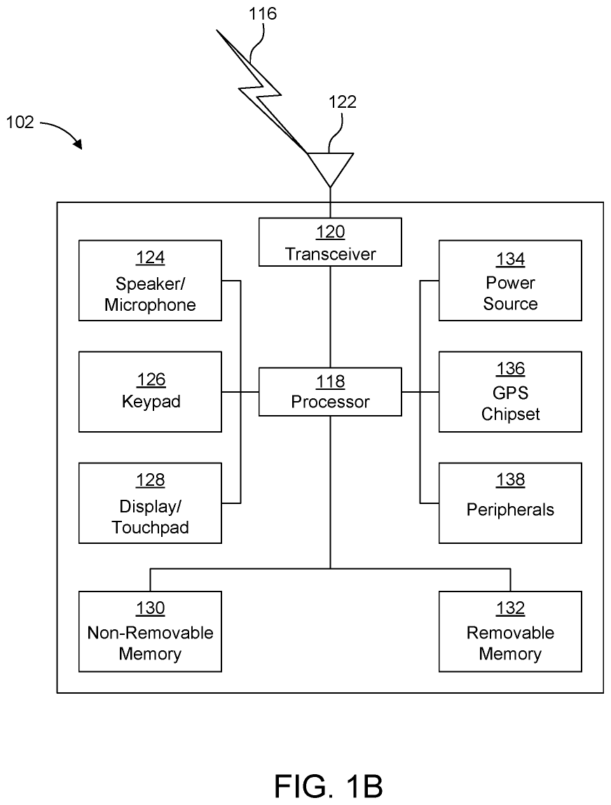

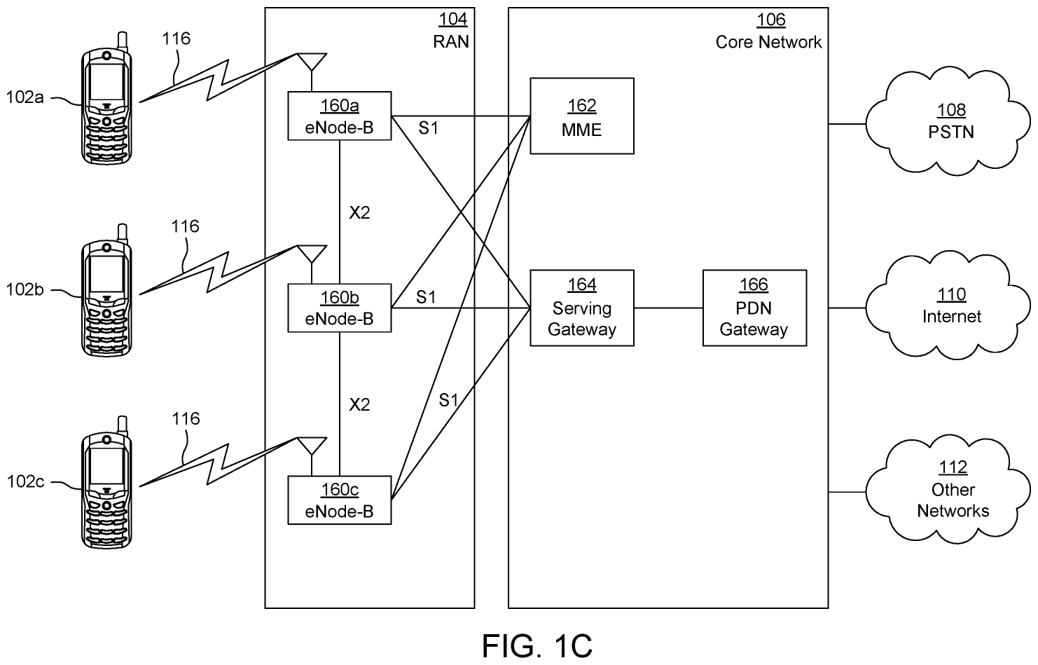

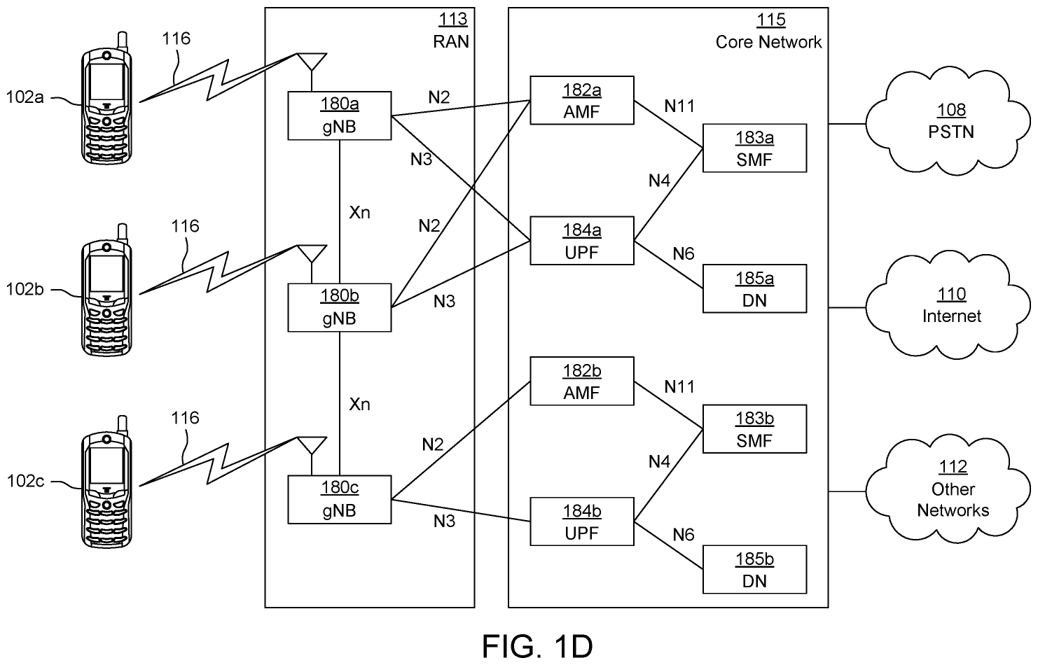

Below are examples of communication systems. The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (IMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Emerging multimodal media applications may require a user to utilize multiple devices/WTRUs for the same application, e.g., a user playing a fully immersive game using VR headset, haptic suit, and a game controller at the same time. Likewise, various emerging IoT applications may require the utilization/deployment of a collection of IoT devices including sensors for serving a single application and a user. In such scenarios, for achieving a common task (e.g., application), a group of WTRUs/devices may be associated with each other and with a specific user for the purpose of the application, improved QoS/QoE, and/or system efficiency. This is in contrast to a user utilizing only a single device for consuming an application, e.g., a user using her mobile device to play a game.

To provide a single service, application or experience for a single user using multiple devices at the same time, there is a need for mechanisms to associate, connect and manage multiple WTRUs together.

Traffic (e.g., data, frames, packets, streams, flows, PDUs) which belong to the same application experience may be distributed across those devices over D2D direct communication links (e.g., sidelinks). For example, direct communication links (e.g., sidelinks) may be utilized to improve user experience or efficiency of the system. Therefore, the delivery (and reception) of those data among the devices that are grouped for a single user, must be associated, and coordinated.

The requirements of the devices and traffic being transferred, for a single multi-modal application (involves multiple modes of communication, e.g., audio, video, haptic), within an aggregated group of WTRUs for a single user may vary. For example, a subset of the traffic may require high priority transmission that is sent to a subset of the devices within the aggregated WTRUs, and if such traffic experiences any disruptions or any degradation to its QoS, the overall services, application or experience will be negatively impacted. In contrast, a subset of devices or traffic in the same aggregated group of WTRUs may be less important, and therefore any disruptions (e.g., delays, dropped packets) to those devices may not significantly affect the overall operation, the end goal of the user (e.g., a task to be performed by a group of WTRUs, devices, Robots or UAVs) or the delivery of crucial data.

A first step in solving above issues may be to identify an aggregation of WTRU/devices that are configured to serve a single user.

The existing 5G procedures may define powerful features, e.g., QoS, session management, mobility management. However, almost all these powerful features are designed for one WTRU. At the network side, the WTRU context may be also managed per WTRU granularity by network functions, e.g., by UDM/SMF/AMF, etc. Moreover, the majority of the features are based on the assumption that one WTRU may finish the task.

The existing 5G procedures do not allow a set of devices in direct D2D communications to be aggregated and associated with a single user. The existing application layer group ID may allow to identify a user within the context of a specific application or to identify a group of users within the context of a specific application. However, this is not sufficient to group a set of WTRUs associated with a specific user for the purpose of consuming a single application or an experience. For example, if two users are playing a game, both using multiple WTRUs, both users may have the same application layer group ID, and does not allow grouping the specific WTRUs being used by each user, and then associate them to the corresponding user.

Moreover, existing procedures and methods do not allow WTRUs/devices to indicate WTRU aggregation capabilities and the interest to join or leave potentially in future to any WTRU aggregations, such that WTRU aggregation capable devices which are available for WTRU aggregation can be identified when the need to aggregation occurs.

Existing procedures and methods do not allow WTRUs to specify the WTRU aggregation it belongs to during direct communication (e.g., sidelink), enabling efficient management of traffic as well as enhanced security.

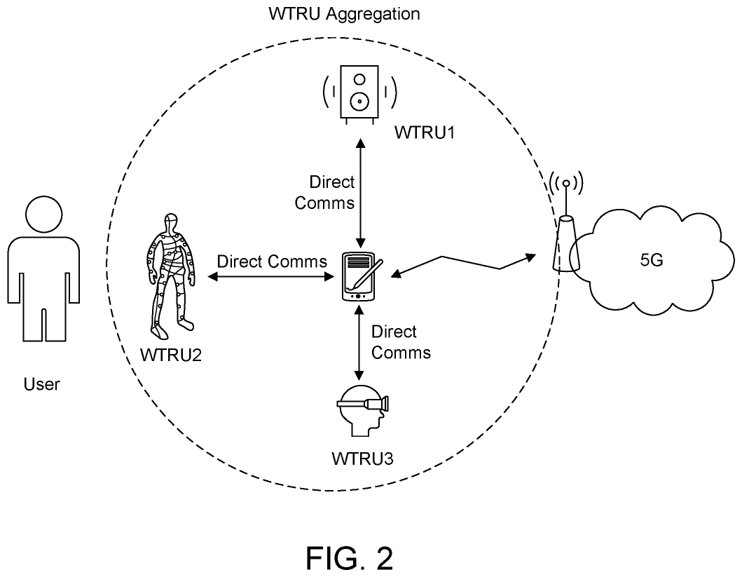

FIG. 2 is a system diagram illustrating an example of a single aggregation of a collection of WTRUs for the purpose of providing an application experience for a single user. This demonstrates that per a given WTRU aggregation, multiple WTRUs with varying form factors (e.g., WTRU1—sound system, WTRU2 haptic suit, and WTRU3—VR goggles—in FIG. 2) may be used, and that they communicate over D2D (e.g., direct comms in FIG. 2) communication mechanisms, for rendering a single experience for the user.

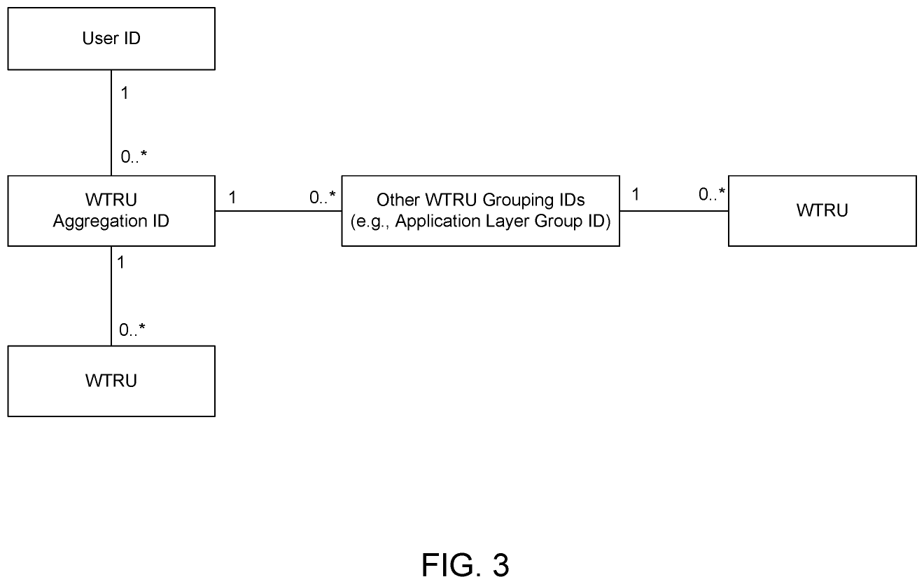

FIG. 3 is block diagram illustrating an example of the relationship between a WTRU aggregation ID and other IDs, aggregated WTRUs, and a user. Referring to FIG. 3, WTRUs may any of a user equipment and a base station. Referring to FIG. 3, a parameter for D2D communication is introduced, defined here as WTRU aggregation ID, for aggregating a set of WTRUs and thus their direct communication links (e.g., sidelinks) for a single user.

A single user may have one WTRU aggregation at a given time (e.g., only one application/experience is being executed for the user, and therefore only one active WTRU aggregation ID). Alternatively, a single user may require more than one application/experience to be executed. Therefore, the user may be associated with more than one WTRU aggregation ID simultaneously. As a non-limited example, in a work environment, one aggregation may be used for a video conference call application, while a second aggregation may be used for a data analytics application where multiple devices may be used for processing and data presentation. Moreover, the WTRU aggregation ID may serve a different functionality to the application layer group ID. For example, if two players are playing the same game, and both users have multiple WTRUs, both users may have the same application layer group ID, but different aggregation IDs.

In scenarios where only one WTRU aggregation is required by the user, a user ID may be used as the WTRU aggregation ID, instead of having to create and maintain a separate ID their mapping. A single WTRU aggregation may be associated with/group multiple WTRUs. In another scenario where existing WTRU grouping ID are used (e.g., Application Layer Group ID) for grouping multiple WTRUs, WTRU aggregation ID may be used for aggregating one or more WTRU groups, for a specific user/application. WTRU aggregation ID may be used for aggregating WTRUs as well as WTRU groups simultaneously.

The layer-2 link for one-to-one direct communication (e.g., sidelink) may be identified by the combination of the layer-2 IDs of the two WTRUs, while the WTRU aggregation ID may be associated with multiple direct communication links (e.g., sidelinks). This also means that a WTRU may use the same WTRU aggregation ID for multiple direct layer-2 links.

In scenarios where multimodal/XR communication services are used, the WTRU aggregation ID may be used for associating multimodal flows in D2D communication.

Below is an example of parameters related to WTRU aggregation. The following table 1 describes parameters that may be related to (e.g., a specific) WTRU aggregation, that are used by various procedures described below. Any procedure that refers to table 1 may include any of the following parameters in messages being transferred.

TABLE 1

| Parameter | Description |
|---|---|
| WTRU aggregation ID(s) | One or more IDs uniquely identifying a |
| | WTRU aggregation. The WTRU aggregation |
| | ID may be a user ID |
| User ID | An identifier uniquely identifying a real user, |
| | e.g., using subscriber information, |
| | SUPI/SUCI. |
| Session ID(s) | The session maybe specified by an IP 5-tuple, |
| | SUPI/SUCI, GPSI, or DNN/S-NSSAI |
| | combination. |
| WTRU IDs | Source/Destination Layer-2 IDs |
| WTRU capabilities | Indication of whether the WTRU supports |
| | WTRU aggregation or supports multiple |
| | simultaneous WTRU aggregations. This may |
| | also include WTRU's computing (e.g., CPU, |
| | RAM) and Communication (e.g., Radio, |
| | WiFi-direct) capabilities. |
| Time Durations | Duration D2D communication to last and |
| | therefore, the resources to be allocated. |
| Application Layer ID | Application Layer IDs associated with direct |
| | communication within the UE aggregation |

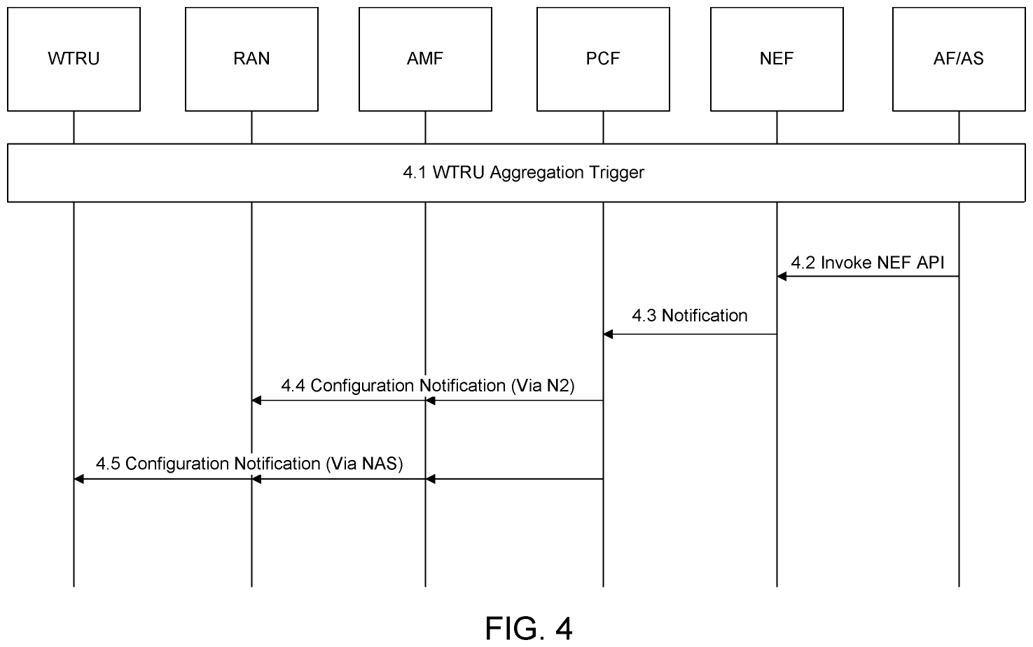

FIG. 4 is a message flow diagram illustrating an example of a WTRU reception of aggregation parameters. More particularly, FIG. 4 is a message flow diagram illustrating exemplary procedures for receiving WTRU aggregation information from an application function (AF). Referring to FIG. 4, the WTRU may be either a user equipment or a base station.

Referring to FIG. 4, at step 4.1, the AF/AS (e.g., V2X Application Server) may create or modify information related to WTRU aggregation grouping that the network as well as WTRUs may have, which may be triggered by an event. For example, change of user location may trigger the network to update WTRU aggregation information, such as newly added devices. Such trigger may also include any event which raises the need for WTRU aggregation (e.g., a user logging onto an application).

At step 4.2, the AF/AS may provide WTRU aggregation related information to the network system by calling a network exposure function (NEF) application programing interface (API). This information may include the WTRU aggregation ID, IP addressed used by the aggregated WTRUs (or any ID identifying direct communication links (e.g., sidelinks), e.g., D2D session IDs), the WTRU IDs identifying each WTRU within the system, user ID (e.g., generic public subscription identifier (GPSI), subscription permanent identifier (SUPI)). NEF may query a binding support function (BSF) for determining which policy control function(s) (PCF(s)) serve the WTRUs, using the information received in Step 4.2. This information may also include WTRU revocation triggers to be used for revoking WTRU aggregation memberships.

At step 4.3, NEF may forward all WTRU aggregation related information received in step 4.2 to the PCF(s) identified. PCF may use the received information to derive relevant configurations related the WTRUs and sessions involved (e.g., police charging and control (rules)). Alternatively, NEF may forward the information directly to the SMF. Alternatively, police control function (PCF) or session management function (SMF) or access and mobility function (AMF) generates a new aggregation ID and stores it to be used for a given WTRU aggregation. In some scenarios, PCF may directly provision WTRU aggregation related information as well as the PCC rules to the SMF. SMF may store received configuration information for later use.

At step 4.4, the PCF may forward the WTRU aggregation information to the RAN via the AMF over an N2 interface, alongside QoS rules.

At step 4.5, the WTRU may receive a configuration message from the network (e.g., 5G) system. The PCF may configure the WTRUs for direct communication (e.g., sidelink) for WTRU aggregation. WTRU aggregation related information may be sent to the WTRU, via the AMF and N1 (non-access stratum (NAS)) interface. This message may also include the QoS rules.

Alternatively, in an embodiment, instead of associating the user, the devices/WTRUs, their communication links using a WTRU aggregation ID, the network (e.g., 5G) system may store and maintain a record of the User-WTRU-Networks/Communication link association in the network (e.g., in SMF, AMF, AF). As an example, the 5G network system may maintain the mapping between the aggregated group of devices and all other existing WTRU grouping IDs (e.g., broadcast group ID) with a specific user.

In other embodiments (e.g., where direct communication is used with no connectivity to the network (e.g., 5G) system, when WTRUs are out of coverage), one of the WTRUs participating in/intending to participate in a new WTRU aggregation may generate a new WTRU Aggregation ID. This ID will then be used in current procedures used for out of coverage direct communication (e.g., sidelink) establishment procedures.

Any combination of information may be pre-configured/pre-provisioned to the WTRUs with WTRU Aggregation capabilities, which may then be used later for WTRU aggregation. For example, the WTRU aggregation parameters may be pre-configured in a library/application at the WTRU provided by WTRU aggregation service provider. In another example, the WTRU may be configured to download the latest WTRU aggregation information from an application server on the internet periodically.

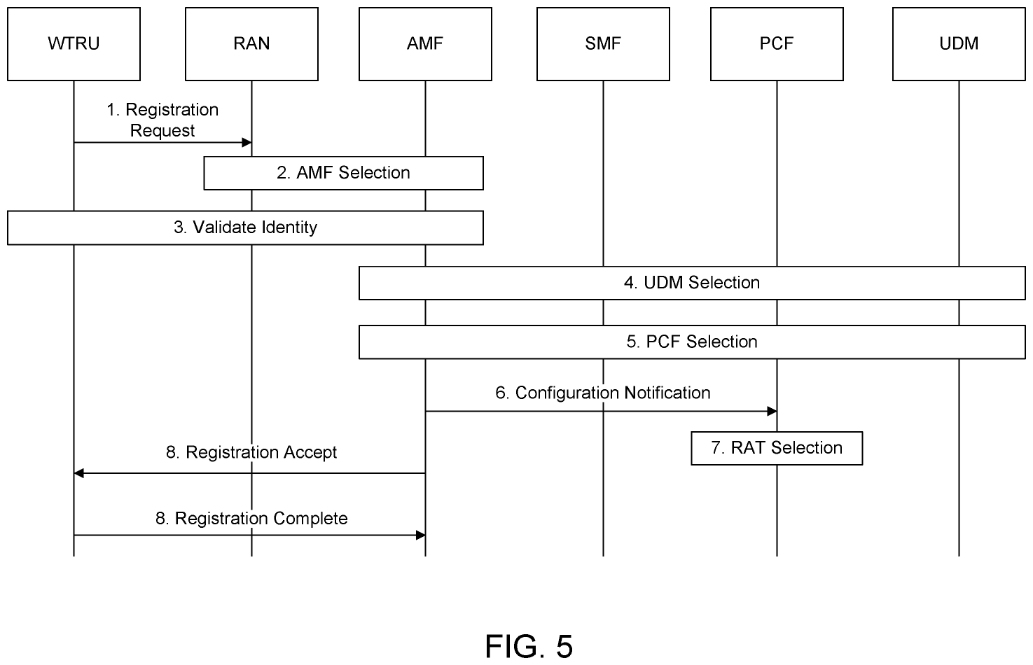

FIG. 5 is a message flow diagram illustrating an example of a WTRU triggered registration procedure. More particularly, FIG. 5 is a message flow diagram illustrating WTRU registration procedures for WTRU aggregation. Referring to FIG. 5, the WTRU may be either a user equipment or a base station. A WTRU aggregation group or multiple WTRU aggregation groups may comprise any of user equipment and base station.

Referring to FIG. 5, at step 5.1, the WTRU may register (or updates existing registration) with the network. The WTRU may indicate its availability and/or capability to be part of a WTRU aggregation group or multiple WTRU aggregation groups. The WTRU may indicate the WTRU aggregation capability in the registration request message. In some scenarios, WTRU aggregation capability may be indicated as part of any of V2X, ProSe, sidelink capability indication.

If the WTRU is already aware of an existing WTRU aggregation that it likes to join, it may include the corresponding WTRU aggregation ID in the registration request message.

If the WTRU is to create a new WTRU aggregation grouping, it includes information specified and received as described above. Alternatively, the WTRU aggregation ID may be created by the network (e.g., by AMF, SMF) and may be sent back to the WTRU in response to the registration request message.

The registration request message may indicate its availability/interest to participate in any WTRU aggregations in the future. In this case, the WTRU shall include any of the following information: WTRU aggregation IDs of the target desired group communications, traffic related requirements information such as UL/DL foreseeable traffic size and type, a specific time at which the WTRU wants to engage in the communications, a time window (if the WTRU can produce it) for which the WTRU wants to engage in communications, and a particular user or WTRU IDs (or a set/subset of them) that the registering WTRU may know in advance it will communicate directly with.

At step 5.2, the RAN (or AMF configured to select an AMF) may select an AMF base on the provided information, if a valid AMF is not already indicated for the communication. The RAN forwards the registration request message to the AMF.

At step 5.3, the network (e.g., 5G) system (AMF) may validate the identity of the WTRU. If the WTRU hasn't already sent the identity related information in step 5.1, it sends identity related information as specified above.

AMF may initiate the WTRU aggregation authentication by invoking authentication server function (AUSF), sending the WTRU aggregation related information.

This extends the existing authentication procedures in clause 4.2.2.2.2 in “TS 23.502, Procedures for the 5G System (5GS); Stage 2 (Release 17); V17.3.0”

At step 5.4, unified data manager (UDM) components may be selected as described in clause 4.2.2.2.2 in “TS 23.502, Procedures for the 5G System (5GS); Stage 2 (Release 17); V17.3.0”. In cases where only some UDM functions support WTRU aggregation functionality, step 5.4 may select ones which support WTRU aggregation features.

At step 5.5, the AMF may select the PCF which supports the WTRU aggregation parameter/policy provisioning and establishes WTRU policy association with the PCF for WTRU policy/parameter provisioning.

At step 5.6, the AMF may report the capabilities received in step 5.1 to the PCF.

At step 5.7, the PCF may determine the WTRU aggregation policy and parameters for specific RAT based on the received WTRU capabilities for WTRU aggregation.

At step 5.8, the WTRU may receive registration accept message from the network (e.g., 5G) system. The accept message may contain the WTRU aggregation ID, either generated by AMF, SMF or PCF, or provided to the network by the AF/AS.

At step 5.9, the WTRU may respond to the network (e.g., 5G) system with a registration complete message.

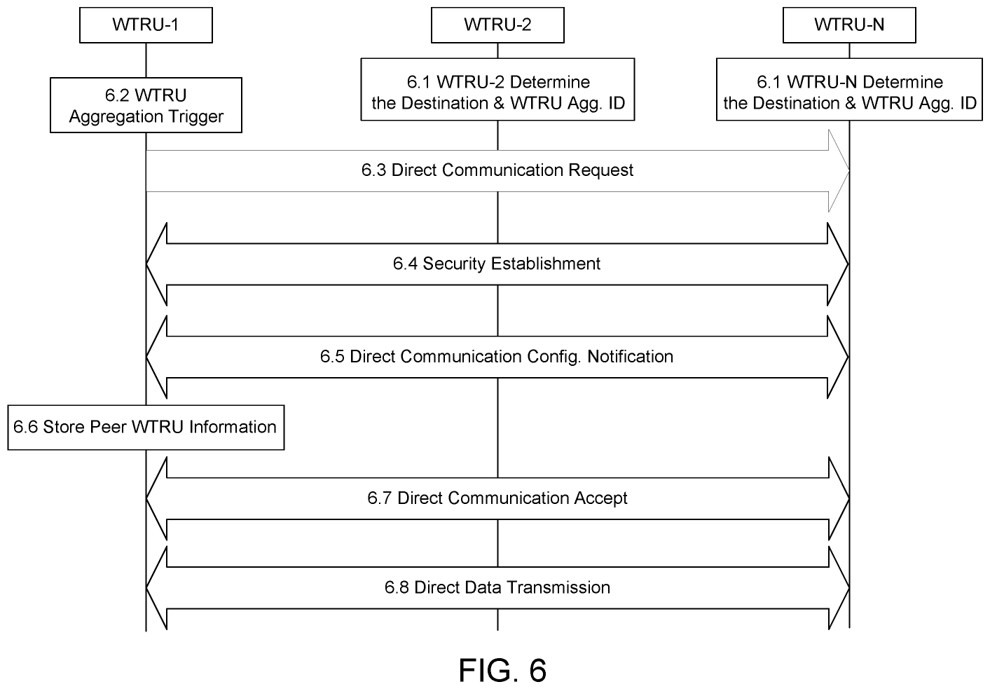

FIG. 6 is a message flow diagram illustrating an example of procedures for establishing direct communication (e.g., sidelink) among WTRUs that are participating in a WTRU aggregation (including WTRU triggers for the aggregation process). The steps below may be repeated when engaging in multiple WTRU aggregations. Step 6.1 details the aggregation ID generation/acquisition/receiving process, while step 6.2 lists the triggers for a WTRU to establish D2D (e.g., sidelink) communications. Remaining steps detail all other relevant procedures for establishing direct communication (e.g., sidelink) between aggregated WTRUs. Referring to FIG. 6, the WTRUs may be any of a user equipment and a base station.

At step 6.1, the WTRUs may determine both the destination layer-2 ID as well as the WTRU aggregation ID for signaling reception for PC5 link (e.g., sidelink) establishment (either generated by WTRUs or received from the network). The layer-2 destination ID may be pre-configured, or dynamically configured. The WTRU aggregation ID may be determined based on the WTRU aggregation information received from the network (as discussed above). Alternatively, the WTRU aggregation ID may be established or generated by the WTRUs themselves, through initial direct control communication among the WTRUs, prior to setting up the direct communication (e.g., sidelink) for data communication. In another setup, the WTRU aggregation ID may be provided to the WTRUs by an application running on the WTRUs.

Other information in step 6.1 in clause 6.3.3.1-1 in “TS 23.287, Architecture enhancements for 5G System (5GS) to support Vehicle-to-Everything (V2X) services; Release 17; V 17.3.0” may be included in this step.

At step 6.2, on WTRU-1, a WTRU aggregation event may trigger an establishment of direct communication (e.g., sidelink) with other WTRUs. Such events may include, but not limited to, application providing information for WTRU aggregation and WTRU direction communication, user or WTRU contextual changes (e.g., change of user location may trigger the WTRU to update WTRU aggregation information and WTRU direct communication), or a scheduled application event where direct (e.g., sidelink) communication to be established based on a pre-configured criteria (e.g., specific time and/or location).

The information received may include direct communication (e.g., ProSe, sidelink, multimodal) service type(s), and the initiating WTRU's application layer ID and the WTRU aggregation ID. WTRU aggregation may be specified here as a new service type (e.g., as a V2X service type or WTRU aggregation as a separately new service type). Any of the target WTRU IDs and application layer IDs may be included in the application information.

The application layer in WTRU 1 may provide application requirements for this PC5 direct (e.g., sidelink) communication (e.g., multimodal flow requirements). It may determine QoS parameters (including PC5 QoS flow identifier (PFI)).

At step 6.3, WTRU-1 may send a direct communication (e.g., sidelink) request to WTRU-N. WTRU-1 may initiate the direct communication (e.g., sidelink) by sending a unicast layer-2 link establishment procedure. When message sent via PC5 (e.g., sidelink) uses the PC5 broadcast or unicast using the source layer-2 ID and the destination layer-2 ID, ProSe/Sidelink direct communication (e.g., sidelink) establishment procedures may be used. Any of the following information may be included in the direct communication (e.g., sidelink) request:

User information that may include an ID uniquely identifying the user (e.g., user ID, subscription information), and WTRU's Application Layer ID.

Source and destination layer-2 IDs of the WTRU as defined in clauses 5.6.1.1 and 5.6.1.4 in “TS 23.287, Architecture enhancements for 5G System (5GS) to support Vehicle-to-Everything (V2X) services; Release 17; V 17.3.0”.

WTRU aggregation ID that uniquely identifying the aggregation of the WTRUs.

Service information that may include any of WTRU aggregation as a new service type, ProSe, Sidelink, and Multimodal service types.

Target WTRU information: Target WTRU's application layer ID (optional)

Time duration the link must be active/used for.

Any combination of information specified above.

If there already exists a link to the target WTRUs, the WTRU may trigger layer-2 link modification procedure.

Any other parameters specified in step 3 in clause 6.3.3.1-1 in “TS 23.287, Architecture enhancements for 5G System (5GS) to support Vehicle-to-Everything (V2X) services; Release 17; V 17.3.0”.

At step 6.4, security may be established with WTRU-1. The target WTRUs may respond by establishing security with WTRU-1 by responding to the direct communication (e.g., sidelink) request message. As part of step 6.4, WTRU aggregation information (e.g., WTRU aggregation ID) may be checked. In case the target WTRU information is not specified in direct communication (e.g., sidelink) request, all WTRUs that are interested in (or authorized for) WTRU aggregation or specified service types, may respond to WTRU-1 for establishing security.

At step 6.5, WTRU-1 and WTRU-2 may exchange information related to the direction communication, IP communication related information such as, IP address configuration, local IP address, IP address allocation mechanism (e.g., specifying if acting as IP router or not), QoS information including information about the QoS flows (e.g., specifying their PFI and PQI and associated services) to be added to the specific direct communication (e.g., sidelink) link (PC5, ProSe, Sidelink) their corresponding QoS parameters.

Some configurations as described in clause 6.3.3 in “TS 23.287, Architecture enhancements for 5G System (5GS) to support Vehicle-to-Everything (V2X) services; Release 17; V 17.3.0” and in clause 5.4.5 in “TS 23.303, Proximity-based services (ProSe); Stage 2 (Release 17); V17.0.0”.

At step 6.6, WTRU-1 may store peer WTRU's layer-2 ID for future communication.

At step 6.7, a direct communication (e.g., sidelink) accept message may be sent by target WTRU(s) that has successfully established security to WTRU-1, if communication acceptance criteria have been met. Otherwise, a direct communication (e.g., sidelink) reject message may be sent. Information in such a criteria may include any of: matching user information, matching WTRU aggregation ID, matching application layer ID, matching WTRU ID received as described above, and have sufficient resources for maintaining the link for the period specified in step 6.3.

The direct communication (e.g., sidelink) accept message may include the information specified in direct communication (e.g., sidelink) establishment requests in steps 6.3 to 6.5 (e.g., QoS information).

Optionally, the direct link (e.g., sidelink) related information established in steps 6.3 to 6.5 (e.g., QoS information) may be sent to the network by the WTRU-1 or by the target WTRU(s). This information is then stored in RAN, and/or in the core network (e.g., SMF, AMF, AF, NWDAF) for monitoring the state of the aggregated WTRUs.

At step 6.8, data may be transmitted over the established unicast link. In some scenarios, WTRU aggregation ID may be included in the messages that is transmitted between the devices (this could be at any chosen layer, e.g., frame, packet). Moreover, any combination of parameters described above may be included.

Below is an example of revocation of WTRUs from an aggregation. The revocation of one or multiple WTRUs may be executed based on various triggers. Some examples may include any of the following trigger events: expiration of time duration the WTRU is authorized to be part of the aggregation, subscriber/user changing her preference to use the particular WTRU(s), malicious activity being detected, and limited resources.

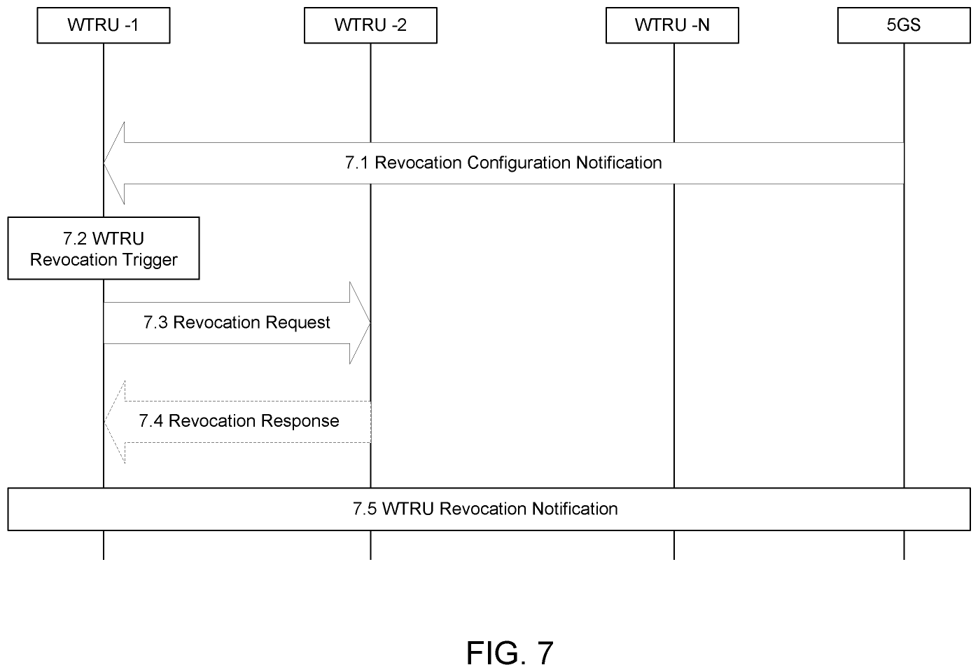

FIG. 7 is a message flow diagram illustrating an example of revoking WTRU memberships from a WTRU aggregation. Referring to FIG. 7, WTRUs may be any of a user equipment and a base station.

At step 7.1, WTRU-1 may receive a revocation configuration notification from a network system (e.g., 5GS). The revocation configuration notification may include IDs of WTRUs to be revoked and WTRU revocation triggers (as described above), in addition to parameters described above. The revocation triggers may be specified as a policy or a set of conditions, specifying when to revoke the membership of the corresponding WTRUs (e.g., revoke WTRU-2 if the user moves from location A). Alternatively, the revocation configuration notification may specify WTRUs to be removed from the WTRU aggregation effective immediately, or after a certain time period.

The revocation configuration notification may be sent from either RAN, AMF, SMF, PCF, AF/AS. Alternatively, the revocation configuration notification may be provided to the WTRU by an application running on the WTRU, or by an application running on a cloud server. In another scenario, the revocation configuration notification may be sent by another WTRU (e.g., a trusted WTRU broadcasting WTRU revocation information).

At step 7.2, WTRU-1 may trigger WTRU revocation, after receiving the revocation configuration notification in step 7.1, or once the conditions for WTRU revocation provided in step 7.1 are met.

At step 7.3, WTRU-1 may send a WTRU revocation request message to WTRU-2, in order to remove WTRU-2 from the WTRU aggregation. The revocation request message may specify any of the WTRU aggregation ID, user/subscriber information, and the reason for the revocation among other parameters described above. Moreover, the revocation request message may include deleting all context and other data associated to the WTRU aggregation. The revocation request message may include releasing layer-2 link. In scenario where multiple WTRUs are removed from the WTRU aggregation, the revocation request message may be sent to all WTRUs that are to be removed from the aggregation.

At step 7.4, WTRU-2 may respond with a WTRU revocation response message to WTRU-1 and may delete all data associated with the WTRU aggregation. Alternatively, UE-2 may send this message to all WTRUs associated with the WTRU aggregation and/or to the network (e.g., 5GS (RAN, AMF, SMF, PCF, AF/AS)), as well as to the application running on the WTRU, for releasing any resources associated with WTRU-2 and to update the WTRU aggregation related information with the current state. In some deployments the revocation response message may be optional.

At step 7.5, the WTRU-1 may notify the application running on the WTRU of the revocation of WTRU-2 (or all removed WTRUs in case where multiple WTRUs are removed) from the WTRU aggregation by transmitting a revocation notification message. WTRU-1 may also send the revocation notification message to all WTRUs associated with the WTRU aggregation and/or to the network (e.g., 5GS (RAN, AMF, SMF, PCF, AF/AS)), for releasing any resources associated with WTRU-2 and to update the WTRU aggregation related information with the current state.

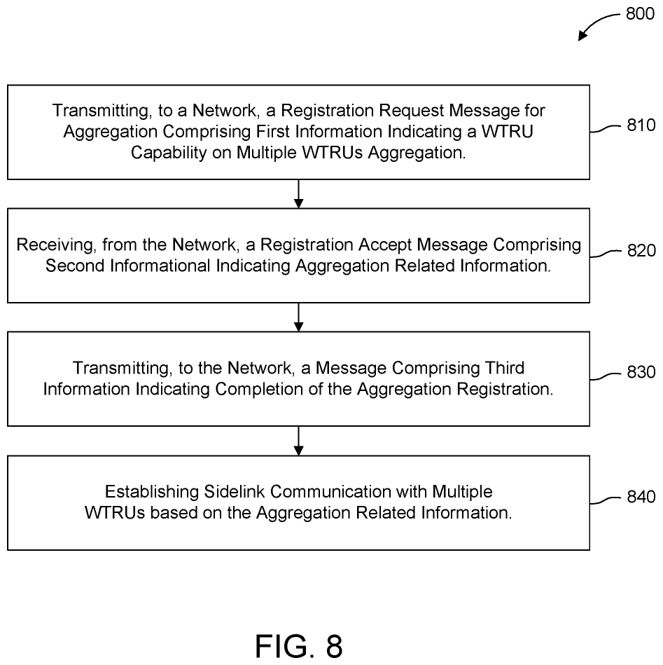

Referring to FIG. 8, a method 800, implemented in a WTRU, for aggregating a WTRU to a WTRU aggregation may comprise a step of transmitting 810, to a network, a registration request message for aggregation comprising first information indicating a WTRU capability on multiple WTRUs aggregation. The aggregation related information may comprise any of one or more WTRU identifiers, a WTRU aggregation identifier, a time window for the WTRU aggregation, and a subscriber identifier. The WTRU capability may comprise an indication whether the WTRU supports single WTRU aggregation or multiple simultaneous WTRU aggregation. The registration request message may comprise an indication of interest in an aggregation operation. The registration request message may comprise a WTRU aggregation identifier associated with the aggregation operation.

The method 800 may further comprise a step of receiving 820, from the network, a registration accept message comprising second information indicating aggregation related information.

The method 800, may further comprise a step of transmitting 830, to the network, a message comprising third information indicating completion of the aggregation registration; and a step of establishing 840 sidelink communication with multiple WTRUs based on the aggregation related information, wherein the sidelink establishment communication is based on a preconfigured trigger event.

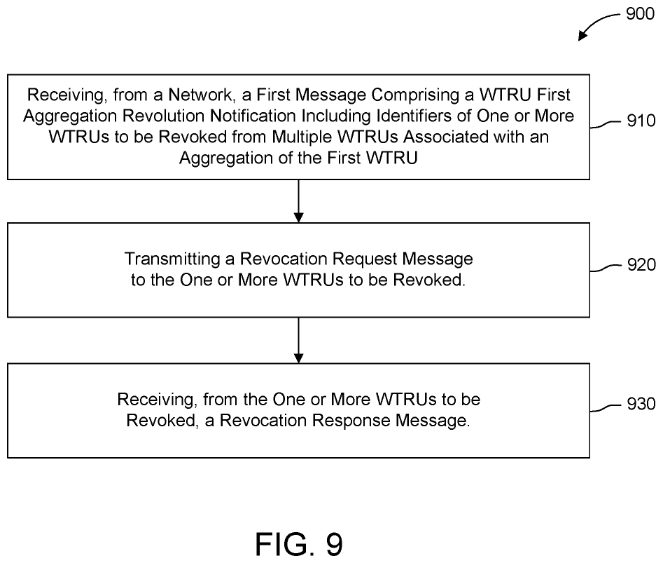

Referring to FIG. 9, a method 900, implemented in a WTRU, for revoking WTRU memberships from a WTRU aggregation may comprise a step of receiving 910, from a network, a first message comprising a WTRU first aggregation revocation notification including identifiers of one or more WTRUs to be revoked from multiple WTRUs associated with an aggregation of the WTRU. The method may further comprise a step of transmitting 920 a revocation request message to the one or more WTRUs to be revoked; and a step of receiving 930, from the one or more WTRUs to be revoked, a revocation response message.

In addition, the method 900 may further comprise a step of transmitting to the non-revoked WTRUs from the multiple WTRUs a second aggregation revocation notification including identifiers of the one or more revoked WTRUs; wherein the second aggregation revocation notification comprises information indicating releasing any resources associated with the one or more revoked WTRUs.

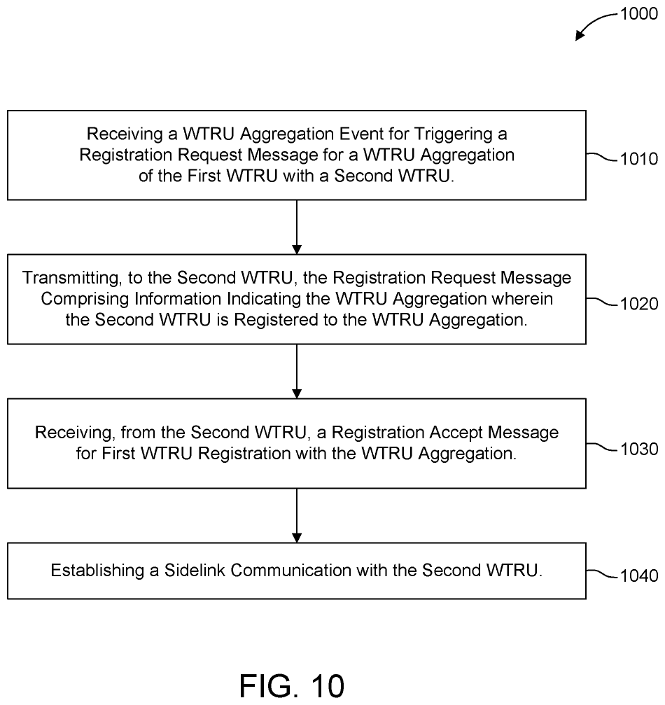

Referring to FIG. 10, a method 1000, implemented in a WTRU, for WTRU aggregation of a first WTRU to a second WTRU part of the WTRU aggregation may comprise a step of receiving 1010 a WTRU aggregation event for triggering a registration request message for a WTRU aggregation of the first WTRU with a second WTRU; wherein the WTRU aggregation event may comprise any of application information for WTRU aggregation and a scheduled application event. The method 1000 may further comprise a step of transmitting 1020 to the second WTRU the registration request message comprising information indicating the WTRU aggregation wherein the second WTRU is registered to the WTRU aggregation. The method 1000 may further comprise a step of receiving 1030, from the second WTRU, a registration accept message for first WTRU registration with the WTRU aggregation; and a step of establishing 1040 a sidelink communication with the second WTRU. Establishing the sidelink communication may comprise exchanging information related to any of a direction communication, an IP communication related information, and QoS information

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-7. (canceled)

8. A method implemented by a first wireless transmit receive unit (WTRU) comprising:
receiving a first message comprising an aggregation revocation configuration notification indicating a first identifier of a second WTRU to be revoked from multiple WTRUs associated with an aggregation of the first WTRU;
transmitting a revocation request message to the second WTRU; and
transmitting, to a third WTRU from the multiple WTRUs an aggregation revocation notification including the first identifier, wherein the aggregation revocation notification comprises first information indicating releasing any resources associated with the second WTRU.

9-19. (canceled)

20. A first wireless transmit/receive unit (WTRU) comprising a processor, a transceiver unit and a storage unit, and configured to:
receive a first message comprising an aggregation revocation configuration notification indicating a first identifier of a second WTRU to be revoked from multiple WTRUs associated with an aggregation of the first WTRU;
transmit a revocation request message to the second WTRU; and
transmit, to a third WTRU from the multiple WTRUs, an aggregation revocation notification including the first identifier, wherein the aggregation revocation notification comprises first information indicating releasing any resources associated with the second WTRU.

21-24. (canceled)

25. The method of claim 8, comprising receiving, from the second WTRU, a revocation response message.

26. The method of claim 8, comprising transmitting, to the third WTRU, the aggregation revocation notification based on that a second identifier of the third WTRU differs from the first identifier.

27. The method of claim 8, wherein the aggregation revocation configuration notification further indicates one or more WTRU revocation triggers specifying when to revoke the second WTRU, the method comprising:
transmitting the revocation request message to the second WTRU, on condition that at least one of the one or more WTRU revocation triggers is met.

28. The method of claim 27, wherein the one or more WTRU revocation triggers comprise one or more trigger events including any of a time duration the second WTRU is authorized to be part of the aggregation, subscriber/user changing her preference to use the second WTRU, a malicious activity being detected at the second WTRU, and limited resources of the second WTRU.

29. The method of claim 8, wherein the first message is received from a network, an application running on the first WTRU, an application running on a cloud server, or from any WTRUs of the multiple WTRUs.

30. The method of claim 8, wherein the revocation request message to the second WTRU comprises second information indicating any of a third identifier of the aggregation of the first WTRU associated with the multiple WTRUs, and the one or more trigger events that the one or more WTRU revocation triggers met.

31. The method of claim 8, wherein the revocation request message to the second WTRU comprises third information indicating deleting all context and other data associated to the aggregation of the first WTRU.

32. The method of claim 8, wherein the aggregation revocation notification comprises fourth information indicating updating fifth information related to the aggregation of the first WTRU.

33. The method of claim 8, wherein the first WTRU is configured as or configured with elements of, a base station.

34. The first WTRU of claim 20, configured to receive, from the second WTRU, a revocation response message.

35. The first WTRU of claim 20, configured to transmit, to the third WTRU, the aggregation revocation notification based on that a second identifier of the third WTRU differs from the first identifier.

36. The first WTRU of claim 20, wherein the aggregation revocation configuration notification further indicates one or more WTRU revocation triggers specifying when to revoke the second WTRU, configured to:
transmit the revocation request message to the second WTRU, on condition that at least one of the one or more WTRU revocation triggers is met.

37. The first WTRU of claim 36, wherein the one or more WTRU revocation triggers comprise one or more trigger events including any of a time duration the second WTRU is authorized to be part of the aggregation, subscriber/user changing her preference to use the second WTRU, a malicious activity being detected at the second WTRU, and limited resources of the second WTRU.

38. The first WTRU of claim 20, wherein the first message is received from a network, an application running on the first WTRU, an application running on a cloud server, or from any WTRUs of the multiple WTRUs.

39. The first WTRU of claim 20, wherein the revocation request message to the second WTRU comprises second information indicating any of a third identifier of the aggregation of the first WTRU associated with the multiple WTRUs, and the one or more trigger events that the one or more WTRU revocation triggers met.

40. The first WTRU of claim 20, wherein the revocation request message to the second WTRU comprises third information indicating deleting all context and other data associated to the aggregation of the first WTRU.

41. The first WTRU of claim 20, wherein the aggregation revocation notification comprises fourth information indicating updating fifth information related to the aggregation of the first WTRU.

42. The first WTRU of claim 20, wherein the first WTRU is configured as or configured with elements of, a base station.
